(19) United States
(12) Patent Application Publication
(10) Pub. No.: US 2011/0311861 A1
(43) Pub. Date: Dec. 22, 2011

(54) BATTERY PACK

(76) Inventors: Woo-Seong BAEK, Yongin-si (KR); Kyung-Won Seo, Yongin-si (KR)

(21) Appl. No.: 12/980,186

(22) Filed: Dec. 28, 2010

(30) Foreign Application Priority Data
Jun. 16, 2010 (KR) 10-2010-0057040

(51) Int. Cl. H01M 2/02

(52) U.S. Cl. 429/178

(57) ABSTRACT

A battery pack includes a battery case including first and second subcases joined with each other; one or more secondary batteries accommodated in the battery case and each including a first electrode and a second electrode; a first electrode terminal in the battery case at a first side; a second electrode terminal in the battery case at a second side opposite the first side; and one or more openings through the battery case and exposing the first and second electrode terminals to an outside of the battery case.

### CROSS-REFERENCE TO RELATED APPLICATION

This application claims priority to and the benefit of Korean Patent Application No. 10-2010-0057040, filed on Jun. 16, 2010 in the Korean Intellectual Property Office, the entire content of which is incorporated herein by reference.

### BACKGROUND

1. Field

Aspects of embodiments of the present invention relate to a battery pack.

2. Description of the Related Art

In general, a battery pack having a plurality of secondary batteries built therein is used as a power source that generates high power.

A battery pack is typically manufactured by accommodating a plurality of secondary batteries in a battery case. However, a typical manner of manufacturing requires several processes for electrically connecting the plurality of secondary batteries to one another. Also, a typical battery pack may be easily damaged by external impact.

### SUMMARY

According to an aspect of embodiments of the present invention, a battery pack having a plurality of secondary batteries accommodated therein is stable and prevents or substantially prevents electrical disconnection due to external impact.

According to another aspect of embodiments of the present invention, a battery pack has a simple manufacturing process and a low production cost because it is unnecessary to attach a separate insulating tape to an electrode terminal.

According to another aspect of embodiments of the present invention, a battery pack has an external appearance which can be easily modified according to electronic devices employed in the battery pack.

According to one embodiment of the present invention, a battery pack includes: a battery case including first and second subcases joined with each other; one or more secondary batteries accommodated in the battery case and each including a first electrode and a second electrode; a first electrode terminal in the battery case at a first side; a second electrode terminal in the battery case at a second side opposite the first side; and one or more openings through the battery case and exposing the first and second electrode terminals to an outside of the battery case.

In one embodiment, the first electrode terminal includes one or more first projections connected to the first electrodes, and the second electrode terminal includes one or more second projections connected to the second electrodes. The first and second projections may be connected to the first and second electrodes of the secondary batteries through resistance welding or laser welding.

The first and second electrode terminals may include nickel.

The first and second subcases may be partitioned about a longitudinal section of a long-side portion of the battery case.

At least one of the first and second subcases may include fixing members at the first and second sides for fixing the first and second electrode terminals. The fixing members may support surfaces of the first and second electrode terminals that are connected to the secondary batteries. In one embodiment, the first electrode terminal is fixed between at least one first fixing member of the fixing members and a first inner surface of the battery case at the first side, and the second electrode terminal is fixed between at least one second fixing member of the fixing members and a second inner surface of the battery case at the second side.

Each of the first and second subcases may include one or more fastening portions joining the first and second subcases with each other. The fastening portions may include an adhesive. The one or more fastening portions may include one or more projections on an inner surface of the first subcase at the first side, and one or more openings at one or more positions corresponding to the projections on an inner surface of the second subcase at the first side. The one or more fastening portions may include one or more projections on an inner surface of the first subcase at a third side of the battery case, and one or more openings at one or more positions corresponding to the projections on an inner surface of the second subcase at the third side. The one or more fastening portions may include one or more projections on an inner surface of the first subcase at the second side, and one or more openings at one or more positions corresponding to the projections on an inner surface of the second subcase at the second side.

The first and second subcases may be joined with each other by an adhesive.

The one or more openings may be at a portion at which at least one of the first or second electrode terminals and the secondary batteries are connected. The one or more openings may correspond to portions at which at least one of the first or second electrode terminals and the secondary batteries are connected at the first or second sides of the battery case. Alternatively, the one or more openings may be integrally formed to be extended and correspond to portions at which at least one of the first or second electrode terminals and the secondary batteries are connected. The one or more openings may have a quadrangular or circular shape.

The first and second electrode terminals may be integrally formed with the battery case through injection molding.

The one or more secondary batteries may have a cylindrical or prismatic shape.

According to an aspect of embodiments of the present invention, a battery pack includes a plurality of secondary batteries and one or more electrode terminals connected to the secondary batteries. One or more openings are provided in upper and lower surface of the battery pack. The electrode terminal is exposed to the exterior of the battery pack through the openings of the battery pack, and the secondary batteries may therefore be electrically connected at the exterior of the battery pack.

According to another aspect of embodiments of the present invention, the electrode terminal is connected to the openings of the battery pack. That is, it is unnecessary to attach a separate insulating tape to the electrode terminal. Thus, an insulating tape and a process of attaching the insulating tape to the electrode terminal may be omitted, production cost can be reduced, and processing efficiency can be improved.

### BRIEF DESCRIPTION OF THE DRAWINGS

The accompanying drawings, together with the specification, illustrate some exemplary embodiments of the present invention, and, together with the description, serve to explain features and principles of the present invention to those of ordinary skill in the art.

FIG. 1 is a perspective view of a cylindrical secondary battery.

FIG. 2 is a sectional view of the cylindrical secondary battery of FIG. 1 taken along line A-A.

FIG. 3 is a perspective view of a battery pack according to an embodiment of the present invention.

FIG. 4 is an exploded perspective view of the battery pack of FIG. 3.

FIG. 5 is a sectional view of the battery pack of FIG. 3 taken along line B-B.

FIG. 6A is an enlarged perspective view showing a first projection and a first through portion of a first fastening portion of the battery pack of FIG. 3 in a disconnected state.

FIG. 6B is an enlarged sectional view showing the first fastening portion of FIG. 6A in a connected state.

FIG. 7 is a plan view showing an upper surface of the battery pack of FIG. 3.

FIG. 8A is a plan view showing an upper surface of a battery pack according to another embodiment of the present invention.

FIG. 8B is a plan view showing an upper surface of a battery pack according to another embodiment of the present invention.

FIG. 9 is a perspective view of a prismatic secondary battery.

FIG. 10 is a sectional view of the prismatic secondary battery of FIG. 9 taken along line A′-A′.

FIG. 11 is a perspective view of a battery pack according to another embodiment of the present invention.

FIG. 12 is an exploded perspective view of the battery pack of FIG. 11.

FIG. 13 is a sectional view of the battery pack of FIG. 11 taken along line B′-B′.

FIG. 14 is a plan view showing an upper surface of the battery pack of FIG. 11.

FIG. 15 is a plan view showing an upper surface of a battery pack according to another embodiment of the present invention.

### DETAILED DESCRIPTION

In the following detailed description, some exemplary embodiments of the present invention are shown and described, by way of illustration. As those skilled in the art would realize, the described embodiments may be modified in various ways without departing from the spirit and scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Like reference numerals refer to like elements throughout the specification and drawings. Also, in the drawings, a thickness or size of one or more layers or components may be exaggerated for clarity and may not necessarily be drawn to scale.

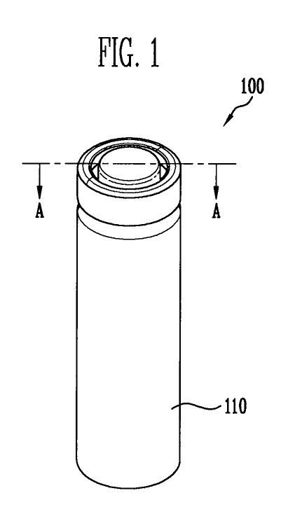

FIGS. 1 to 7 are views showing a battery pack according to an embodiment of the present invention.

First, a battery pack manufactured by accommodating a plurality of cylindrical secondary batteries will be described.

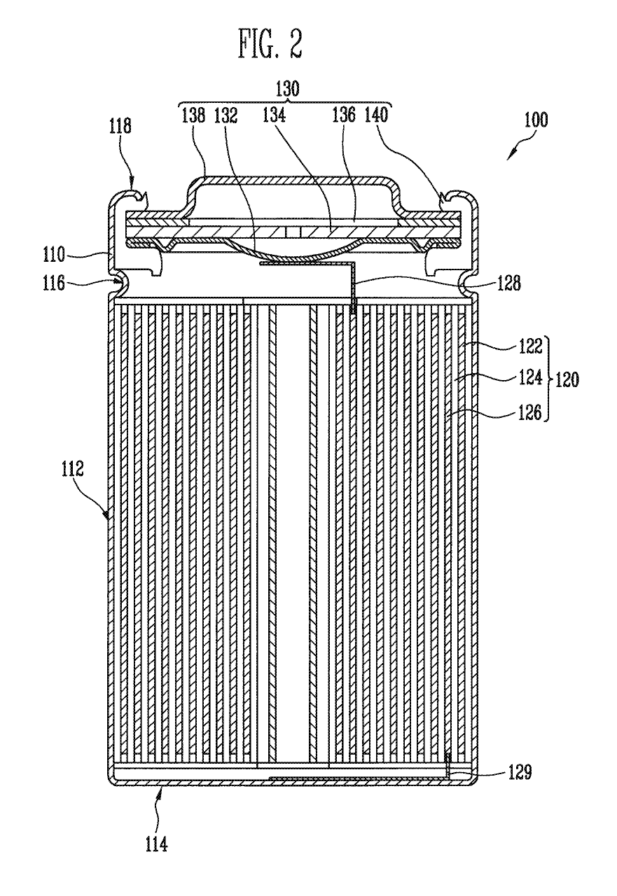

FIG. 1 is a perspective view of a cylindrical secondary battery 100. FIG. 2 is a sectional view of the cylindrical secondary battery 100 taken along line A-A of FIG. 1.

Referring to FIGS. 1 and 2, the cylindrical secondary battery 100 includes a cylindrical can 110, an electrode assembly 120, and a cap assembly 130.

The cylindrical can 110 accommodates the electrode assembly 120 and an electrolyte. The cap assembly 130 is coupled to an upper portion of the cylindrical can 110 to seal the cylindrical can 110 so that the electrode assembly 120 is not removed from the cylindrical can 110.

The electrode assembly 120 may include a first electrode plate 122 having a positive electrode active material coated on a single surface or both surfaces thereof; a second electrode plate 126 having a negative electrode active material coated on a single surface or both surfaces thereof; and a separator 124 interposed between the first and second electrode plates 122 and 126. The first electrode plate 122 is a positive electrode plate, and may be formed of, for example, an aluminum thin film or the like. A positive electrode non-coating portion on which the positive electrode active material is not coated may be located at an end of the first electrode plate 122. The second electrode plate 126 is a negative electrode plate, and may be formed of a conductive metal thin film, e.g., a copper or nickel thin film. A negative electrode non-coating portion on which the negative active material is not coated may be located at an end of the second electrode plate 126.

The electrode assembly 120 may include a first electrode lead 128 attached to the positive electrode non-coating portion of the first electrode plate 122, and a second electrode lead 129 attached to the negative electrode non-coating portion of the second electrode plate 126.

The separator 124 is interposed between the first and second electrode plates 122 and 126 to prevent or substantially prevent the first and second electrode plates 122 and 126 from coming in direct contact with each other. Thus, the separator 124 prevents or substantially prevents a short circuit between the first and second electrode plates 122 and 126 and provides a pathway for ions.

The electrode assembly 120, in one embodiment, is formed by winding the first electrode plate 122, the separator 124, and the second electrode plate 126 in a jelly roll shape. The electrode assembly 120 may be accommodated in the cylindrical can 110.

The cylindrical can 110 may include a cylindrical side surface 112 having a constant diameter to form a space in which the electrode assembly 120 is accommodated, and a bottom surface 114 that closes the bottom of the side surface 112. The top of the cylindrical can 110 includes an opening through which the electrode assembly 120 is inserted into the cylindrical can 110.

In one embodiment, the second electrode lead 129 attached to the negative electrode non-coating portion of the electrode assembly 120 is connected to the bottom surface 114 of the cylindrical can 110. Accordingly, the cylindrical can 110 can be electrically connected to the second electrode plate 126 to serve as a negative electrode terminal.

The cylindrical can 110, in one embodiment, has a crimping portion 118 formed at an upper portion thereof to be bent toward the interior thereof. The crimping portion 118 presses an upper portion of the cap assembly 130 that seals the opening of the cylindrical can 110. Also, the cylindrical can 110, in one embodiment, has a beading portion 116 formed to be bent toward the interior thereof. The beading portion 116 fixes the cap assembly 130 at a position spaced by a distance corresponding to the thickness of the cap assembly 130 from the crimping portion 118.

The cap assembly 130, in one embodiment, includes a safety vent 132, a current blocking portion 134, a positive temperature device 136, an electrode cap 138, and an insulating gasket 140.

The safety vent 132 is formed of a metallic material, and may be connected to the first electrode lead 128 connected to the positive electrode non-coating portion so as to be electrically connected to the first electrode plate 122. The current blocking portion 134 is disposed on the safety vent 132 to be electrically and mechanically connected to the safety vent 132, and may be broken down when the safety vent 132 is deformed or ruptured. The positive temperature device 136 is disposed on the current blocking portion 134 to be electrically and mechanically connected to the current blocking portion 134. The electrode cap 138 is disposed on the positive temperature device 136 to be electrically and mechanically connected to the positive temperature device 136, and may serve as a terminal through which current is applied to the exterior of the secondary battery. The insulating gasket 140, in one embodiment, surrounds side circumferences of the safety vent 132, the current blocking portion 134, the positive temperature device 136, and the electrode cap 138 so as to fix them. Also, the insulating gasket 140, in one embodiment, insulates the electrode cap 138 that serves as the positive electrode from the cylindrical can 110 that serves as the negative electrode.

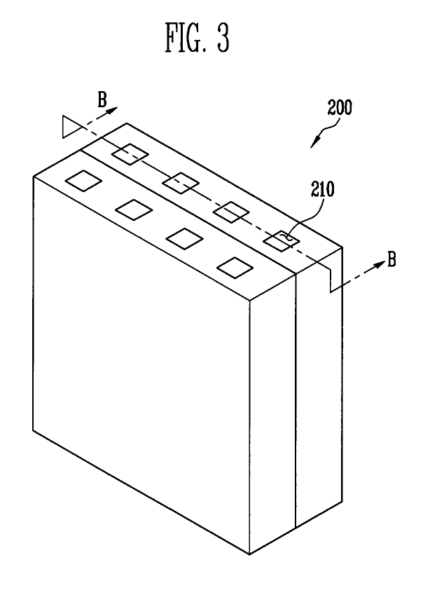

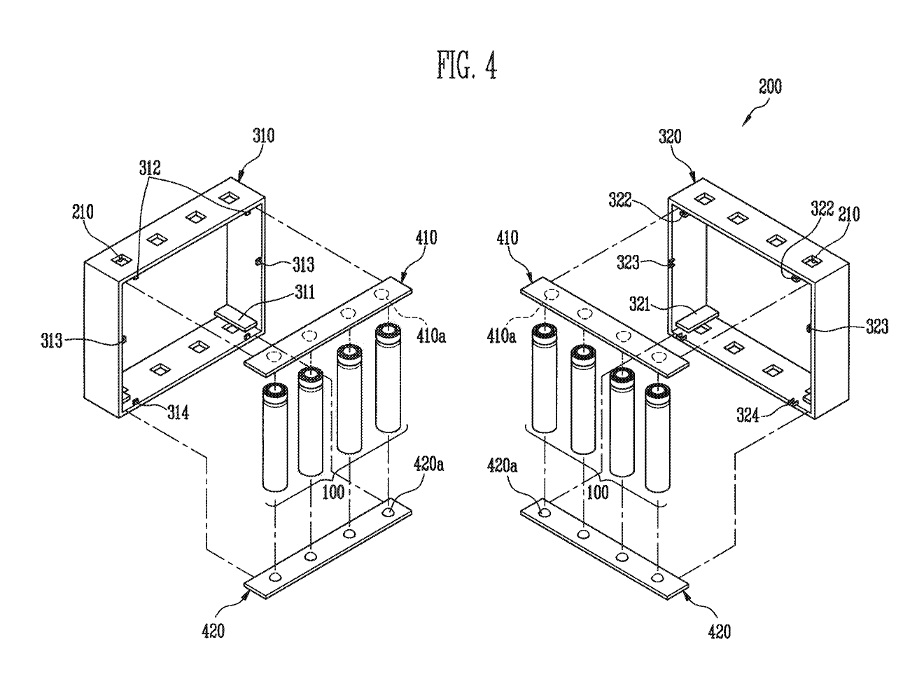

FIG. 3 is a perspective view of a battery pack 200 according to an embodiment of the present invention. FIG. 4 is an exploded perspective view of the battery pack 200. FIG. 5 is a sectional view of the battery pack 200 taken along line B-B shown in FIG. 3.

Referring to FIGS. 3 and 4, the battery pack 200 according to one embodiment of the present invention includes a plurality of cylindrical secondary batteries 100, first and second subcases 310 and 320, and first and second electrode terminals 410 and 420. Each of the first and second subcases 310 and 320 has the shape of a hexahedron with an open side. Thus, a battery case is formed by joining the open side of the first subcase 310 with the open side of the second subcase 320, corresponding to the open side of the first subcase 310. In FIG. 3, the first and second subcases 310 and 320 that constitute the battery case are illustrated as a rectangular hexahedron. However, the shape of the first and second subcases 310 and 320 may be modified according to electronic devices and the like, which employ the battery pack 200 including the first and second subcases 310 and 320.

Eight cylindrical secondary batteries 100 included in the battery pack 200 according to one embodiment are illustrated in FIG. 4. Four of the cylindrical secondary batteries 100 are inserted into each of the first and second subcases 310 and 320. However, in other embodiments of the present invention, the total number of cylindrical secondary batteries 100 included in the battery pack 200, and the connection structure of the cylindrical secondary batteries 100 accommodated in the interior of the battery pack 200 are not limited to those shown in the figures but may be variously modified according to the use of the battery pack 200 and the designed capacity of the battery pack 200.

The first and second subcases 310 and 320 may be manufactured using polymer resin or the like. For example, the polymer resin may include polyethylene, polypropylene, polyethylene terephthalate, polycarbonate, nylon, and the like. The first and second subcases 310 and 320 are made of an insulating material. Thus, the first and second subcases 310 and 320 are not electrically connected to the secondary batteries 100 and the first and second electrode terminals 410 and 420, which are inserted into the first and second subcases 310 and 320.

A plurality of openings 210 are provided at upper and lower sides of each of the first and second subcases 310 and 320. The first and second electrode terminals 410 and 420 are exposed to the exterior of the battery case through the openings 210. In one embodiment, the first electrode terminal 410 is exposed through the upper side of each of the first and second subcases 310 and 320, and the second electrode terminal 420 is exposed through the lower side of each of the first and second subcases 310 and 320. The openings 210 provided at the lower side may be positioned to correspond to the respective openings 210 provided at the upper side. As such, the first and second electrode terminals 410 and 420 electrically connect the secondary batteries 100 to the exterior of the battery case through the openings 210. The openings 210 may be provided at one side or both sides of each of the first and second subcases 310 and 320. This may be varied according to the shape of the battery case. For example, in a battery case where the secondary batteries 100 are inserted into any one of the first and second subcases 310 and 320, unlike the battery case shown in FIG. 4, the openings 210 may be provided in only the subcase into which the secondary batteries 100 are inserted. Since it is sufficient that the openings 210 electrically connect the secondary batteries 100 inserted into the subcases to the exterior of the battery case through the first and second electrode terminals 410 and 420, the shape and number of the openings 210 is not limited.

In one embodiment, the first and second subcases 310 and 320 are manufactured through a molding process or the like, and the openings 210 may be integrally formed in the molding process. Alternatively, in another embodiment, after the first and second subcases 310 and 320 are manufactured, the openings 210 may be formed using a knife, a drill, or the like.

In one embodiment, fixing members 311 and 321 extend inward from the first and second subcases 310 and 320 and are provided on the first and second subcases 310 and 320, respectively. The fixing members 311 and 321, in one embodiment, are provided to both upper and lower ends of sides of the first and second subcases 310 and 320, respectively. The fixing members 311 and 321 fix the first and second electrode terminals 410 and 420 to upper and lower portions of the first and second subcases 310 and 320, respectively. Thus, the first and second electrode terminals 410 and 420 are thereby held in place in the interior of the battery case against movement due to external impact, and are firmly attached to the secondary batteries 100 to connect the secondary batteries 100 to the exterior of the battery case. As shown in FIG. 4, the first electrode terminal 410, in one embodiment, is inserted into a gap between the upper side of each of the first and second subcases 310 and 320 and the fixing members 311 and 321 extending inward from the sides of the first and second subcases 310 and 320 near the upper sides, and the second electrode terminal 420 is inserted into a gap between the lower side of each of the first and second subcases 310 and 320 and the fixing members 311 and 321 extending inward from the sides of the first and second subcases 310 and 320 near the lower sides. Although it is illustrated in FIG. 4 that after the first and second subcases 310 and 320 and the first and second electrode terminals 410 and 420 are individually manufactured, the first and second electrode terminals 410 and 420 are inserted into the first and second subcases 310 and 320, respectively, embodiments of the present invention are not limited thereto. For example, the electrode terminals may be integrally formed with each of the subcases using a method such as injection molding. In this case, the electrode terminals are previously fixed to each of the subcases. Therefore, in another embodiment, the fixing members for fixing the electrode terminals may be absent from each of the subcases.

The structure in which the secondary batteries 100 are connected to the first and second electrode terminals 410 and 420 in the interior of each of the first and second subcases 310 and 320 will now be described with reference to FIGS. 4 and 5. In the first electrode terminal 410, projections 410a are formed on an opposite surface to that on which portions exposed through the respective openings 210 are formed. The projections 410a are formed to respectively correspond to the secondary batteries 100 inserted into each of the first and second subcases 310 and 320 to come in contact with the first and second electrode terminals 410 and 420. For example, in one embodiment, four secondary batteries 100 are inserted into the first subcase 310, as shown in FIG. 5, four projections 410a are formed on the first electrode terminal 410, and, similarly, four projections 420a are formed on the second electrode terminal 420 inserted into the first subcase 310. In one embodiment, the projections 420a formed on the second electrode terminal 420 are formed at positions corresponding to the projections 410a formed on the first electrode terminal 410, respectively. The first and second electrode terminals 410 and 420 electrically connect the secondary batteries 100 to the exterior of the battery case. However, the positions of the projections 410a and 420a respectively formed on the first and second electrode terminals 410 and 420 may not necessarily be formed to correspond to each other. In one embodiment, where the positions of the projections 410a and 420a respectively formed at the first and second electrode terminals 410 and 420 are formed to correspond to each other, the first and second electrode terminals 410 and 420 have the same shape. Also, the first and second electrode terminals 410 and 420 may be formed of the same material. For example, in one embodiment, the first and second electrode terminals 410 and 420 are interchangeable and may be used without being distinguishable from each other. Thus, it is possible to reduce a production cost of the battery pack 200 and to decrease the rate of failures that may occur in a manufacturing process of the battery pack 200.

In the first and second subcases 310 and 320, the first electrode terminals 410 are fixed to upper portions of the first and second subcases 310 and 320, respectively, and the second electrode terminals 420 are fixed to lower portions of the first and second subcases 310 and 320, respectively. Subsequently, a plurality of cylindrical secondary batteries 100 are inserted into each of the first and second subcases 310 and 320. In this instance, the first electrode terminals 410, specifically the projections 410a provided on the first electrode terminals 410 come in contact with cap assemblies 130 (see FIG. 2) of the cylindrical secondary batteries 100, respectively. Also, the projections 420a provided on the second electrode terminals 420 come in contact with bottom surfaces of the secondary batteries 100, respectively.

As such, the projections 410a and 420a formed on the electrode terminals 410 and 420 in the interior of the battery case contact the cap assembly 130 and the bottom surface of the secondary batteries 100, respectively. The electrode terminals 410 and 420 contact the secondary batteries 100, so that the secondary batteries 100 can be electrically connected to the exterior of the battery case. In one embodiment, welding portions 411 and 421 are formed using a method such as welding so that the electrode terminals 410 and 420 are strongly joined with the secondary batteries 100. The welding portions 411 and 421 may be formed using a method such as resistance welding or laser welding.

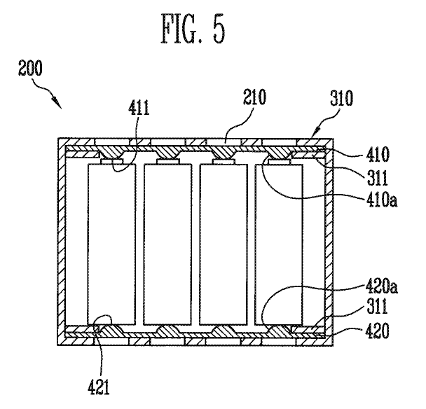

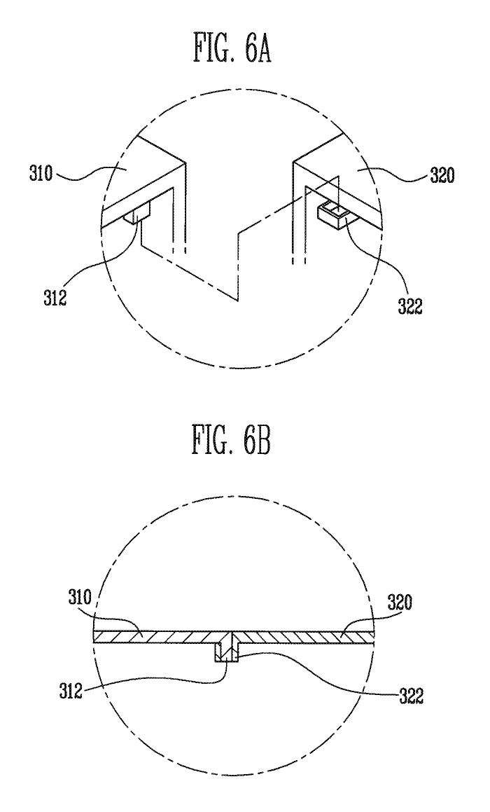

Referring to FIGS. 4 and 6A, in one embodiment, the first and second subcases 310 and 320 of the battery pack 200 are partitioned about a longitudinal section of a long side portion of the battery pack 200. In one embodiment, the fixing members 311 (see FIG. 5) and one or more fastening portions 312, 313, and 314 are included on the first subcase 310. Similarly, in one embodiment, the fixing members 321 (see FIG. 5) and one or more fastening portions 322, 323, and 324 are included on the second subcase 320.

As described above, the fixing members 311 and 321 (see FIG. 5) for fixing the first and second electrode terminals 410 and 420 and the fastening portions 312, 313, 314, 322, 323, and 324 for fastening the first and second subcases 310 and 320 to each other are formed on the first and second subcases 310 and 320. The fastening portions 312, 313, and 314 and the fastening portions 322, 323, and 324 are provided on upper, lower, and side surfaces of the first and second subcases 310 and 320, respectively, so that the first and second subcases 310 and 320 are firmly joined with each other. In other embodiments, the positions of the fastening portions may be changed according to the subcases. Also, the number and positions of the fastening portions 312, 313, 314, 322, 323, and 324 may be variously changed, and an adhesive may be used as an additional joining means.

The fastening portions 312, 313, and 314 and the fastening portions 322, 323, and 324 are provided on the upper, lower, and side surfaces of the first and second subcases 310 and 320, respectively. After the first and second subcases 310 and 320 are joined with each other using the fastening portions 312, 322, 313, 323, 314, and 324, the portions at which the first and second subcases 310 and 320 face each other may be more firmly joined by using an additional adhesive or the like. In another embodiment, the fastening portions 312, 322, 313, 323, 314, and 324 may be absent and the first and second subcases 310 and 320 may be joined with each other using only an adhesive.

In one embodiment, the first fastening portions 312 and 322 are provided on the upper surfaces of the first and second subcases 310 and 320, respectively; the second fastening portions 313 and 323 are provided on the side surfaces of the first and second subcases 310 and 320, respectively; and the third fastening portions 314 and 324 are provided on the lower surfaces of the first and second subcases 310 and 320, respectively. The fastening portions 312, 322, 313, 323, 314, and 324 are provided at positions corresponding to each other in the respective first and second subcases 310 and 320. With reference to FIG. 4, the first fastening portions 312 and 322 are provided on both ends of the respective upper surfaces, the third fastening portions 314 and 324 are provided on both ends of the respective lower surfaces, and the second fastening portions 313 and 323 are provided on center portions of both side surfaces of the first and second subcases 310 and 320, respectively. However, since it is sufficient that the subcases are joined with each other, the position and shape of the fastening portions 312, 322, 313, 323, 314, and 324 are not limited to those shown in FIG. 4. In one embodiment, the fastening portions 312, 322, 313, 323, 314, and 324 are integrally formed to extend inward from the first and second subcases 310 and 320. However, in another embodiment, the fastening portions 312, 322, 313, 323, 314, and 324 may be formed as additional members to be attached to the first and second subcases 310 and 320.

Various methods such as a hook joining method, a hole and projection joining method, or a combination thereof may be applied in the first fastening portions 312 and 322, the second fastening portions 313 and 323, and the third fastening portions 314 and 324. In one embodiment, the hole and projection joining method is applied in each of the first fastening portions 312 and 322, the second fastening portions 313 and 323, and the third fastening portions 314 and 324.

FIG. 6A is an enlarged perspective view showing a first projection and a first through portion of a first fastening portion in a disconnected state. FIG. 6B is an enlarged sectional view showing the first fastening portion in a connected state. A joint between the first fastening portion (a “first projection”) 312 and the first fastening portion (a “first through portion”) 322 will now be described.

Referring to FIGS. 6A and 6B, the first projection 312 is provided on the inside of the first subcase 310, and the first through portion 322 is provided at a position corresponding to the first projection 312 on the inside of the second subcase 320. In one embodiment, a groove is formed in the first through portion 322 so that the first projection 312 provided on the first subcase 310 can pass therethrough. Also, in one embodiment, the first through portion 322 is formed to be stepped at a side surface of the second subcase 320 so that the groove is exposed to the exterior of the second subcase 320. In one embodiment, as shown in FIGS. 6A and 6B, the first projection 312 is provided on the first subcase 310, and the first through portion 322 is provided on the second subcase 320. However, since it is sufficient that the first projection 312 and the first through portion 322 are joined with each other at positions corresponding to each other, the positions of the first projection 312 and the first through portion 322 are not limited. The above description of the first projection 312 and the first through portion 322 is applicable to projections and through portions that constitute the second fastening portions 313 and 323 and the third fastening portions 314 and 324. Therefore, a detailed description thereof will be omitted.

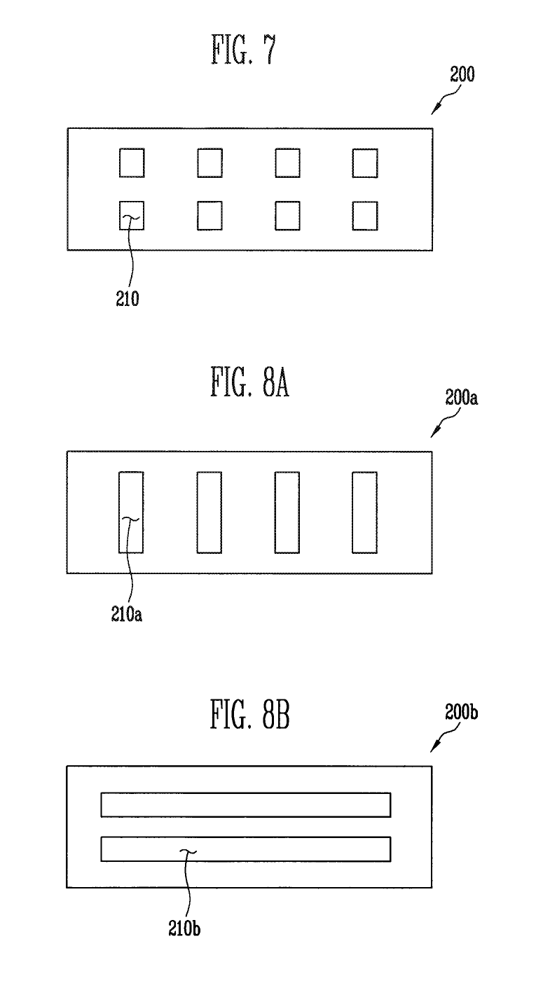

FIG. 7 is a plan view showing an upper surface of the battery pack 200 according to an embodiment of the present invention. FIGS. 8A and 8B are plan views showing upper surfaces of a battery pack according to other embodiments of the present invention.

Referring to FIG. 7, a plurality of openings 210 are formed in the upper and lower surfaces of the battery pack 200 according to an embodiment of the present invention. The first and second electrode terminals 410 and 420 are exposed to the exterior of the battery pack 200 through the openings 210. The first electrode terminal 410 is electrically connectable on the exterior of the battery pack 200 through the openings 210 formed in the upper surface, and the second electrode terminal 420 is electrically connectable on the exterior of the battery pack 200 through the openings 210 formed in the lower surface (not shown in FIG. 7). The openings 210 formed in the upper and lower surfaces may be formed at positions corresponding to each other.

Although in FIGS. 4 and 7 the openings 210 are shown corresponding to the number of secondary batteries 100 that constitute the battery pack 200, embodiments of the present invention are not limited thereto. FIGS. 8A and 8B illustrate upper surfaces of battery packs according to other embodiments of the present invention. As shown in FIGS. 8A and 8B, openings 210a and 210b of respective battery packs 200a and 200b are formed in numbers that do not correspond to the number of secondary batteries 100 accommodated in the interior of the battery case. In the embodiments shown in the drawings, the shapes of the openings 210, 210a, and 210b are quadrangles, but, in other embodiments, the openings 210, 210a, and 210b may have various shapes or combinations of shapes, such as a circle and a triangle. Although only the upper surface of the battery pack 200 has been illustrated in FIGS. 7 to 8B, the shapes of the openings shown in FIGS. 7 to 8B may be applied to the lower surface of the battery pack 200. Therefore, a detailed description thereof will be omitted.

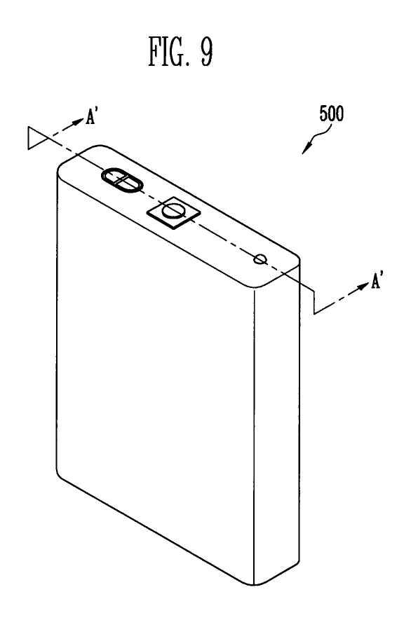

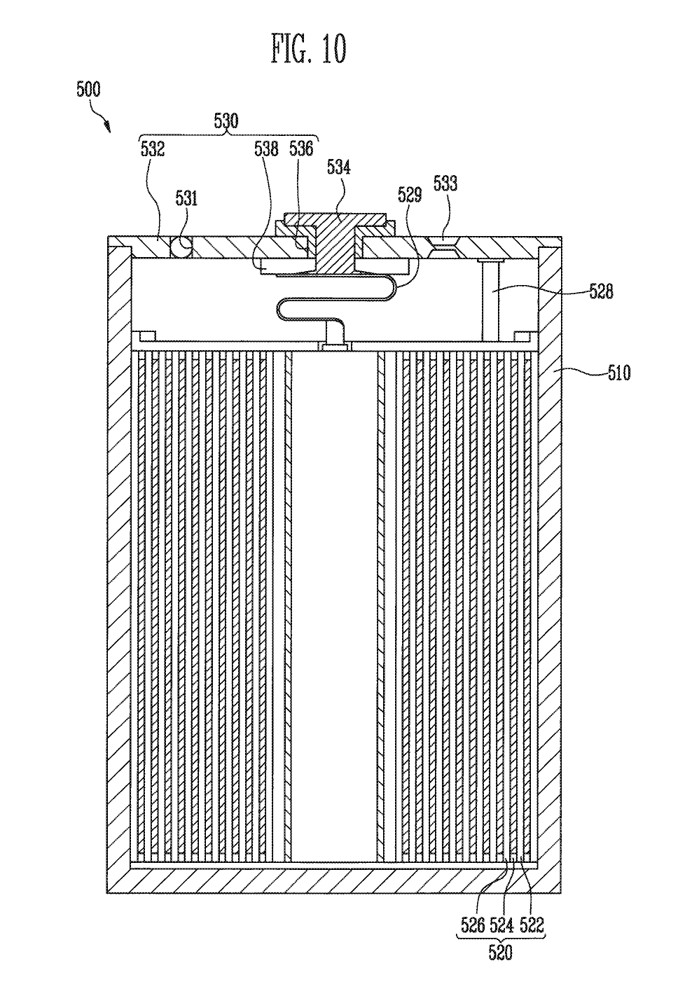

FIGS. 9 to 14 are views showing a battery pack 600 according to another embodiment of the present invention.

Hereinafter, the battery pack 600 manufactured by accommodating a plurality of prismatic secondary batteries will be described.

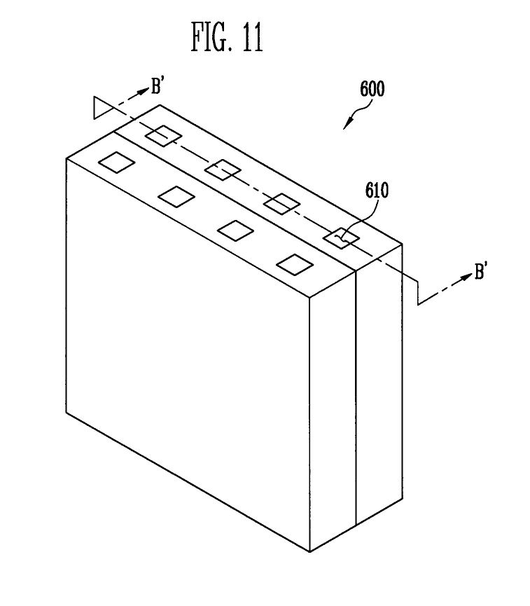

FIG. 9 is a perspective view of a prismatic secondary battery 500. FIG. 10 is a sectional view of the prismatic secondary battery 500 taken along line A′-A′ shown in FIG. 9.

Referring to FIGS. 9 and 10, the prismatic secondary battery 500 includes a prismatic can 510, an electrode assembly 520, and a cap assembly 530.

The prismatic can 510 accommodates the electrode assembly 520 and an electrolyte. The cap assembly 530 is coupled to an upper portion of the prismatic can 510 to seal the prismatic can 510 so that the electrode assembly 520 is not removed from the prismatic can 510.

The electrode assembly 520, in one embodiment, includes a first electrode plate 522 having a positive electrode active material coated on a single surface or both surfaces thereof; a second electrode plate 526 having a negative electrode active material coated on a single surface or both surfaces thereof; and a separator 524 interposed between the first and second electrode plates 522 and 526. The first electrode plate 522 is a positive electrode plate, and may be formed of, for example, an aluminum thin film or the like. A positive electrode non-coating portion on which the positive electrode active material is not coated may be located at an end of the first electrode plate 522. The second electrode plate 526 is a negative electrode plate, and may be formed of a conductive metal thin film, e.g., a copper or nickel thin film. A negative electrode non-coating portion on which the negative active material is not coated may be located at an end of the second electrode plate 526.

The electrode assembly 520, in one embodiment, includes a first electrode lead 528 attached to the positive electrode non-coating portion of the first electrode plate 522, and a second electrode lead 529 attached to the negative electrode non-coating portion of the second electrode plate 526.

The separator 524 is interposed between the first and second electrode plates 522 and 526 to prevent or substantially prevent the first and second electrode plates 522 and 526 from coming in direct contact with each other. Thus, the separator 524 prevents or substantially prevents a short circuit between the first and second electrode plates 522 and 526 and provides a pathway for ions.

The electrode assembly 520, in one embodiment, is formed by winding the first electrode plate 522, the separator 524, and the second electrode plate 526 in a jelly roll shape. The electrode assembly 520 may be accommodated in the prismatic can 510.

The prismatic can 510, in one embodiment, is a rectangular hexahedron, and is formed of an aluminum or aluminum alloy container having an open top. The prismatic can 510 has a predetermined space in which the electrode assembly 510 is accommodated, and the top of the prismatic can 510 includes an opening through which the electrode assembly 520 is inserted into the prismatic can 510.

In one embodiment, the first electrode lead 528 is attached to the non-coating portion of the first electrode plate 522 and protrudes upward from the electrode assembly 520, and the second electrode lead 529 is attached to the non-coating portion of the second electrode plate 526 and protrudes upward from the electrode assembly 520. The first and second electrode leads 528 and 529 protruded from the electrode assembly 520 are spaced apart from each other at a predetermined distance to be electrically insulated from each other. The first and second electrode leads 528 and 529 may be formed of a metal, such as nickel.

The cap assembly 530, in one embodiment, includes a cap plate 532 that seals the top of the prismatic can 510; a negative electrode pin 534 that passes through the cap plate 532; a gasket 536 interposed between the cap plate 532 and the negative electrode pin 534; and an insulating plate 538 formed on a lower surface of the cap plate 532.

The cap plate 532 is formed of a metal plate having a size and shape corresponding to that of the top opening of the prismatic can 510. A hole having a predetermined size is formed at the center of the cap plate 532 such that the negative electrode pin 534 is inserted into the prismatic can 510 through the hole. When the negative electrode pin 534 is inserted into the hole, the tubular gasket 536 is joined with the negative electrode pin 534 on the outer surface of the negative electrode pin 534, and the negative electrode pin 534 and the gasket 536 are inserted together into the hole. An electrolyte injection hole 531 may be formed at one side of the cap plate 532. In one embodiment, after the cap assembly 530 is assembled to the top opening of the prismatic can 510, the electrolyte is injected into the prismatic can 510 through the electrolyte injection hole 531, and the electrolyte injection hole 531 is pressed and sealed by a separate sealing portion such as a ball-shaped material, which is formed of metal containing aluminum. Also, a safety vent 533 may be formed at the other side of the cap plate 532. The safety vent 533 enables gas to be exhausted when an internal pressure in the prismatic can 510 rises and reaches or exceeds a certain pressure.

The negative electrode pin 534, in one embodiment, is connected to the second electrode lead 529 of the second electrode plate 526 to serve as a negative terminal. Thus, the second electrode lead 529 extracted from the second electrode plate 526 is welded to the bottom portion of the negative electrode pin 534 in a state in which the second electrode lead 529 has a zigzag shaped bent portion. The first electrode lead 528, in one embodiment, is extracted from the first electrode plate 522 to be welded to a lower surface of the cap plate 532. In one embodiment, a welding method for joining the first and second electrode leads 528 and 529 may include resistance welding, laser welding, or the like. In one embodiment, resistance welding is used as the welding method.

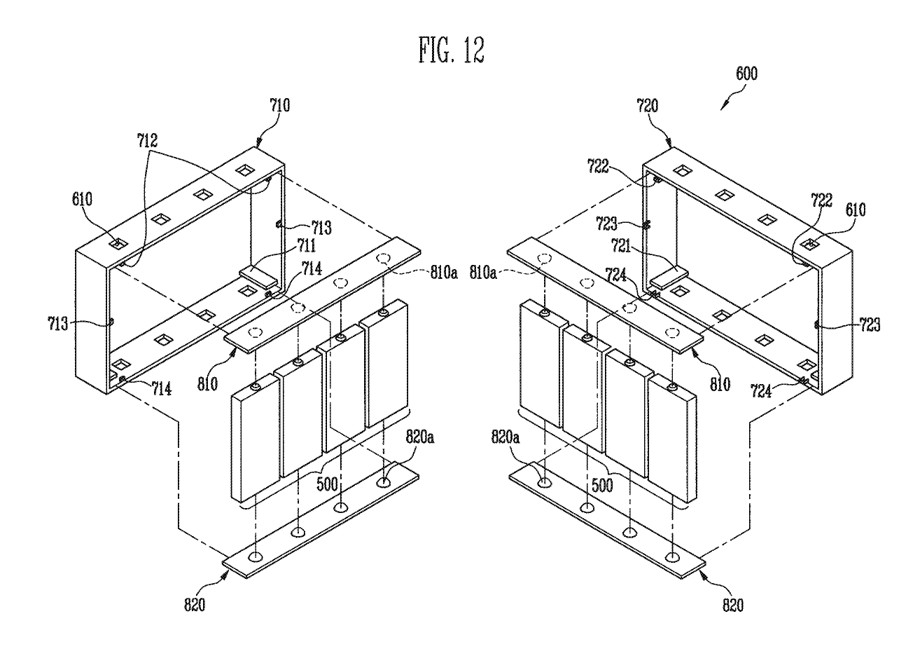

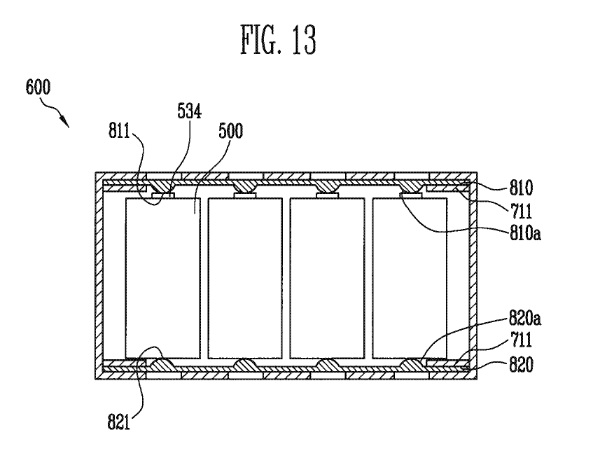

FIG. 11 is a perspective view of the battery pack 600 according to an embodiment of the present invention. FIG. 12 is an exploded perspective view of the battery pack 600. FIG. 13 is a sectional view of the battery pack 600 taken along line B′-B′of FIG. 11.

The battery pack 600 according to an embodiment of the present invention includes a plurality of prismatic secondary batteries 500, first and second subcases 710 and 720, and first and second electrode terminals 810 and 820.

The first and second subcases 710 and 720, in one embodiment, are partitioned about a longitudinal section of a long side portion of the battery pack 600, and each of the first and second subcases 710 and 720 has one open surface. In one embodiment, fastening portions are provided on the subcases 710 and 720. Thus, the first and second subcases 710 and 720 are fastened and joined with each other by the fastening portions in a state in which the open surfaces of the first and second subcases 710 and 720 are opposite to each other. Accordingly, in one embodiment, a battery case having a hexahedron shape is formed.

Referring to FIGS. 11 and 12, a plurality of openings 610 are provided on an upper surface of the battery pack 600 according to an embodiment of the present invention. In one embodiment, the openings 610 are formed in upper and lower surfaces of the first and second subcases 710 and 720. Each of the openings 610 formed in the upper surface serves as a path along which the first electrode terminal 810 is connectable at the exterior of the battery case, and each of the openings 610 formed in the lower surface serves as a path along which the second electrode terminal 820 is connectable at the exterior of the battery case. The openings 610 may be formed in the process of manufacturing the first and second subcases 710 and 720. Alternatively, after the first and second subcases 710 and 720 are formed through injection molding or the like, the openings 610 may be formed using a knife, a drill, or the like. Since the configuration and function of the first and second subcases 710 and 720 is the same as those of the first and second subcases 310 and 320 (see FIGS. 3 to 6B) according to the aforementioned embodiment, detailed descriptions thereof will be omitted.

Referring to FIGS. 12 and 13, fixing members 711 are provided at both upper and lower ends of long sides of the first subcase 310, and fixing members 721 are provided at both upper and lower ends of long sides of the second subcase 320. The first and second electrode terminals 810 and 820 are held against moving in the interior of the battery case by the fixing members 711 and 721, and are firmly attached to the secondary batteries 500. Although it is illustrated in FIG. 12 that after the first and second subcases 710 and 720 and the first and second electrode terminals 810 and 820 are individually manufactured, the first and second electrode terminals 810 and 820 are inserted into the first and second subcases 710 and 720, respectively, embodiments of the present invention are not limited thereto. That is, in another embodiment, the first and second subcases 710 and 720 may be manufactured using a method such as molding, and the first and second electrode terminals 810 and 820 may be integrally formed into a single body. Also, although it is shown in FIG. 12 that the fixing members 711 and 721 are provided at both sides of the upper and lower surfaces of the first and second subcases 710 and 720, respectively, positions and shapes of the fixing members 711 and 721 are not limited to those shown in FIG. 12.

Since, in one embodiment, the fixing members 711 and 721 are the same or substantially the same as the fixing members 311 and 321 described above, further description of the fixing members 711 and 721 is omitted.

In one embodiment, the first and second electrode terminals 810 and 820 are fixed to each of the first and second subcases 710 and 720. Then, the prismatic secondary batteries 500 are inserted into each of the first and second subcases 710 and 720. The secondary batteries 500 come in contact with the first and second electrode terminals 810 and 820 in the battery case.

In the first electrode terminal 810, projections 810a are formed on an opposite surface to that on which portions exposed through the respective openings 610 are formed. The projections 810a come in contact with the negative electrode pins 534 (see FIG. 10) provided on the cap assemblies 530 (see FIG. 10) of the respective secondary batteries 500. In one embodiment, the projections 810a on the first electrode terminals 810 are welded to the negative electrode pins 534 (see FIG, 10) of the secondary batteries 500 that come in contact with the projections 810a at the lower portions of the projections 810a using a method such as resistance welding or laser welding, thereby forming welding portions 811 (see FIG. 13). The openings 610 that pass through the first subcase 710 are provided at the upper surfaces of the welding portions 811 formed between the projections 810a of the first electrode terminal 810 and the secondary batteries 500, and the secondary batteries 500 are electrically connected to the exterior of the battery case through the openings 610. Similarly, in the second electrode terminal 820, projections 820a are formed on an opposite surface to that on which portions exposed through the respective openings 610 are formed. The projections 820a come in contact with bottom surfaces of the respective secondary batteries 500 (see FIGS. 12 and 13). In one embodiment, the projections 820a on the second electrode terminals 820 are welded to the bottom surfaces of the respective secondary batteries 500 that come in contact with the projections 820a at the upper portions of the projections 820a using a method such as resistance welding or laser welding, thereby forming welding portions 821 (see FIG. 13).

The fastening portions, in one embodiment, are provided at upper, lower, and side surfaces of the first and second subcases 710 and 720. The fastening portions join the first and second subcases 710 and 720 with each other. The fastening portions, in one embodiment, are provided at the upper, lower, and side surfaces of the first and second subcases 710 and 720, respectively, so that the first and second subcases 710 and 720 are firmly joined with each other. In the battery pack 600 according to one embodiment, the positions and number of fastening portions for joining the first and second subcases 710 and 720 may be varied according to the size and shape of the first and second subcases 710 and 720 or an adhesive used as an additional joining means. In addition to the joint between the first and second subcases 710 and 720 through fastening portions 712, 722, 713, 723, 714, and 724, the first and second subcases 710 and 720 may be more firmly joined with each other by using an adhesive or the like. Also, in another embodiment, the fastening portions 712, 722, 713, 723, 714, and 724 may be absent, and the first and second subcases 710 and 720 may be joined with each other, such as using only an adhesive.

In the fastening portions 712, 722, 713, 723, 714 and 724 of the first and second subcases 710 and 720 according to one embodiment, the first fastening portions 712 and 722 are provided at the upper surfaces of the first and second subcases 710 and 720, respectively; the second fastening portions 713 and 723 are provided at the side surfaces of the first and second subcases 710 and 720, respectively; and the third fastening portions 714 and 724 are provided at the lower surfaces of the first and second subcases 710 and 720, respectively. The fastening portions 712, 722, 713, 723, 714, and 724 are provided at positions corresponding to each other in the respective subcases 710 and 720, so that the first and second subcases 710 and 720 are firmly joined with each other. Although it is illustrated in FIG. 12 that the fastening portions 712, 722, 713, 723, 714, and 724 are provided to both ends of the upper surface, both ends of the lower surface and center portions of both side surfaces of the first and second subcases 710 and 720, embodiments of the present invention are not limited thereto. The fastening portions 712, 722, 713, 723, 714, and 724 may be integrally formed with the first and second subcases 710 and 720, or may be formed separately from the first and second subcases 710 and 720 and then attached to the first and second subcases 710 and 720.

Various methods such as a hook joining method, a hole and projection joining method or a combination thereof may be applied to the fastening portions. In one embodiment, the fastening portions 712, 722, 713, 723, 714, and 724 are the same or substantially the same as the fastening portions 312, 322, 313, 323, 314, and 324 described above and, therefore, further detailed description thereof will be omitted.

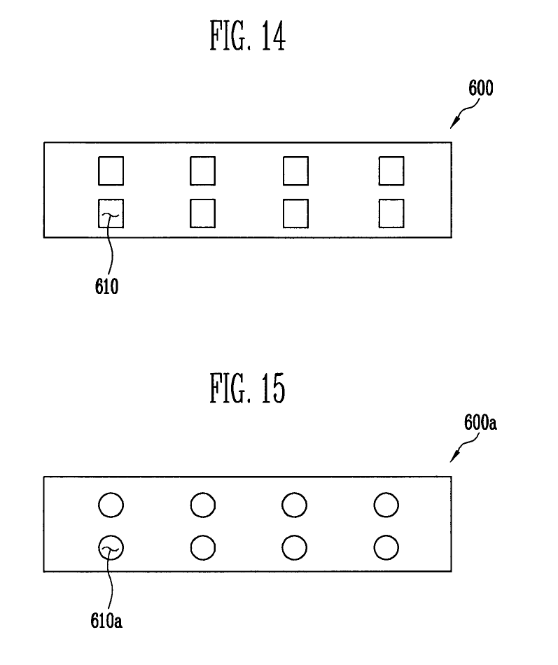

FIG. 14 is a plan view showing an upper surface of the battery pack 600 according to an embodiment of the present invention. FIG. 15 is a plan view showing an upper surface of a battery pack according to another embodiment of the present invention.

Referring to FIG. 14, a plurality of openings 610 is formed in the battery pack 600 according to an embodiment of the present invention. The first and second electrode terminals 810 and 820 are exposed to the exterior of the battery pack 600 through the openings 610. Although in one embodiment, as illustrated in FIG. 14, each of the openings 610 is formed to correspond to one of the secondary batteries 500 of the battery pack 600, embodiments of the present invention are not limited thereto. For example, FIG. 15 shows an upper surface of a battery pack 600a according to another embodiment of the present invention. As shown in FIG. 15, openings 610a are formed regardless of the kind and number of secondary batteries 500 accommodated in a battery case. Also, the openings 610a may have the shape shown in FIG. 8A or 8B. Although only the openings 610a formed in the upper surface of the battery pack 600a are illustrated in FIG. 15, the openings formed in a lower surface of the battery pack 600 may correspond to the openings 610a shown in the upper surface. Therefore, a detailed description thereof will be omitted.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A battery pack comprising:
a battery case comprising first and second subcases joined with each other;
one or more secondary batteries accommodated in the battery case and each comprising a first electrode and a second electrode;
a first electrode terminal in the battery case at a first side;
a second electrode terminal in the battery case at a second side opposite the first side; and
one or more openings through the battery case and exposing the first and second electrode terminals to an outside of the battery case.

2. The battery pack according to claim 1, wherein the first electrode terminal comprises one or more first projections connected to the first electrodes, and the second electrode terminal comprises one or more second projections connected to the second electrodes.

3. The battery pack according to claim 2, wherein the first and second projections are connected to the first and second electrodes of the secondary battery through resistance welding or laser welding.

4. The battery pack according to claim 1, wherein the first and second electrode terminals comprise nickel.

5. The battery pack according to claim 1, wherein the first and second subcases are partitioned about a longitudinal section of a long-side portion of the battery case.

6. The battery pack according to claim 1, wherein at least one of the first and second subcases comprises fixing members at the first and second sides for fixing the first and second electrode terminals.

7. The battery pack according to claim 6, wherein the fixing members support surfaces of the first and second electrode terminals that are connected to the secondary batteries.

8. The battery pack according to claim 6, wherein the first electrode terminal is fixed between at least one first fixing member of the fixing members and a first inner surface of the battery case at the first side, and the second electrode terminal is fixed between at least one second fixing member of the fixing members and a second inner surface of the battery case at the second side.

9. The battery pack according to claim 1, wherein each of the first and second subcases comprises one or more fastening portions joining the first and second subcases with each other.

10. The battery pack according to claim 9, wherein the one or more fastening portions comprise an adhesive.

11. The battery pack according to claim 9, wherein the one or more fastening portions comprise one or more projections on an inner surface of the first subcase at the first side, and one or more openings at one or more positions corresponding to the projections on an inner surface of the second subcase at the first side.

12. The battery pack according to claim 9, wherein the one or more fastening portions comprise one or more projections on an inner surface of the first subcase at a third side of the battery case, and one or more openings at one or more positions corresponding to the projections on an inner surface of the second subcase at the third side.

13. The battery pack according to claim 9, wherein the one or more fastening portions comprise one or more projections on an inner surface of the first subcase at the second side, and one or more openings at one or more positions corresponding to the projections on an inner surface of the second subcase at the second side.

14. The battery pack according to claim 1, wherein the first and second subcases are joined with each other by an adhesive.

15. The battery pack according to claim 1, wherein the one or more openings are at a portion at which at least one of the first or second electrode terminals and the secondary batteries are connected.

16. The battery pack according to claim 15, wherein the one or more openings correspond to portions at which at least one of the first or second electrode terminals and the secondary batteries are connected at the first or second sides of the battery case.

17. The battery pack according to claim 15, wherein the one or more openings are integrally formed to be extended and correspond to portions at which at least one of the first or second electrode terminals and the secondary batteries are connected.

18. The battery pack according to claim 15, wherein the one or more openings have a quadrangular or circular shape.

19. The battery pack according to claim 1, wherein the first and second electrode terminals are integrally formed with the battery case through injection molding.

20. The battery pack according to claim 1, wherein the one or more secondary batteries have a cylindrical or prismatic shape.
